(19) United States
(12) Patent Application Publication
(10) Pub. No.: US 2004/0078355 A1
(43) Pub. Date: Apr. 22, 2004

(54) Information management system

(76) Inventor: Ashok Suresh, Norwalk, CA (US)

Correspondence Address: Norman E. Carte, Myers Dawes Andras & Sherman LLP, Suite 1150, 19900 MacArthur Blvd, Irvine, CA, 92612, US

(21) Appl. No.: 10/661,387

(22) Filed: Sep. 12, 2003

Related U.S. Application Data
(60) Provisional application No. 60/410,721, filed on Sep. 13, 2002.

(51) Int. Cl. G06F 7/00

(52) U.S. Cl. 707/1

(57) ABSTRACT

An information management system has an object management unit for storing object data of more than one kind in a common general format regardless of the kind of object data. A format management unit stores a format for each specific kind of object. A filter management unit for storing a plurality of filters. A database management control unit converts the object data between the common general format stored in the object management unit and the specific format for retrieval based on a respective one of a plurality of filters stored in the filter management unit. Object data is correlated with a filter identifier which specifies which filter is to be utilized when the object is retrieved.

### FIELD OF THE INVENTION

The present invention relates generally to information processing and database management systems, and relates more specifically to methods of searching for objects in a database. According to another aspect of the invention relates more particularly to methods of storing attributes of an object in linearized mode in a database system.

### BACKGROUND OF THE INVENTION

Computer systems are powerful machines by which vast amount of information can be stored and retrieved with little effort from the user. There are many forms of information that can be stored in many different types of formats. A database is a collection of organized related information stored in a computer. The computer stores such information in records where each record typically has a plurality of fields to store the information within. Application programs utilize these collections of information as a separate entity from the program itself. This separate entity does not consist of executable code, but rather merely consists of information that application programs can execute functions upon.

As a common practice, a database management system is a software layer that runs upon an operating system within computers. The database management system acts upon the information stored in the database on the behalf of the application program. Sometimes this software layer is embedded into the application program, so that direct action can be taken without an actual database system running. Sometimes the database management system is an independent program. In either case, the actual information is protected through this layer. A typical database consists of several tables in which individual records are stored. Tables are preformatted when constructed and predefine the fields of each record that will be stored within it. It is the collection of tables and the collection of records within each table which creates this collection of information.

Thus, database management systems for facilitating the storage, organization and retrieval of information are well known. Thus, a database management system facilitates the use and management of a database. Examples of contemporary database management systems include Microsoft Access, Microsoft SQL, and Oracle.

As mentioned above, contemporary database management systems store a plurality of records, wherein each record is typically defined by a plurality of fields. Each record relates to an entry for a different item and each field of a record contains some information relating to that item. For example, each record may relate to a different person and each field of the record may give information about the person, such as the person's name, telephone number and address.

Although such contemporary database structure has proven generally useful for its intended purpose, contemporary database structure suffers from inherent deficiencies which detract from its overall utility. Examples of such deficiencies include the requirement of a contemporary database to have records generally all of a particular type. It is difficult to integrate diverse subject matter into a single contemporary database.

In the above example, all of the records contain information relating to people. Contemporary databases are not well suited for the inclusion of information regarding diverse subject matter, such as people, cars, product sales, and songs in a single database. Rather, information regarding each of these different items must generally be stored in a completely separate database according to contemporary practice. As though skilled in the art will appreciate, the use of such separate databases inherently requires that each database be utilized separately in order to find desired information. Of course, this complicates the tasks which must be performed in order to locate a desired record, particularly when a user is not certain which database the record is contained within.

Additionally, in a contemporary database management system the fields associated with each record must be predefined prior to use of the database and cannot easily be changed at a later time. Sometimes, it is actually necessary to create a second database (having a new field structure) and import data thereinto from the first database, in order to modify the field structure thereof. That is, if it is desired to add a field, for example, then a second database must be created having the desired structure (the additional field, for example) and then the data is imported from the first database into the second database. Again, this substantially complicates the use of the database management system. Indeed, contemporary database management systems are so complex that typical users rarely attempt to perform such modification to the structure thereof and must rely upon the assistance of experts in order to perform such functions.

Thus, the use of contemporary databases and their associated tables presents substantial limitations with respect to real world applications. First, after creating a database and its associated tables, it is difficult to add fields to the table since all the records already in the table and the record structure have to be modified as discussed above. This means that a database administrator has to modify the tables using the database management system or add an additional table for each field added that has to be linked to each record in the already existing table. This cannot be done by the application program due to the separation by the database management system layer. Thus, contemporary database management systems do not facilitate adding attributes, or fields, to the records within the table during runtime.

Second, since there are typically many fields associated with each record, when searching for certain record entities you must know beforehand what table the record is stored in and what fields to search within a table according to your search criteria. Contemporary database management systems do not facilitate a universal search of all fields and all tables.

Third, according to contemporary practice there is a way to link record entities with other record entities within another table of the database or even within the same table, but such links must generally be predefined at the creation of the table. Links can also be defined at a later time via modification of the database, but such later modification is comparatively difficult since it cannot be directly done by the application program and cannot be done during runtime. Such later modification of the links also involves the modification of every record within the tables being altered.

Fourth, usually the storage of such record information within a table is based upon a horizontal scheme wherein the record entities are being stored row by row within tables. The use of such a horizontal scheme inherently has substantial disadvantages, as discussed in detail below.

Commonly, the database tables are also structured upon creation to store only particular types of records. The type of static fields contained within each record is predefined during the table creation process and thus, as mentioned above, are difficult to alter or add to. As a result of these predefined fixed field types, the types of record entities, or data objects, which can be stored within a table as a record are limited. These objects are based upon an object oriented approach to storing data. Such objects represent executable instruction and/or data. These objects have a list of descriptions giving it definition, usually noted as its attributes. Thus, when one of these objects is stored within a database, the object's attributes are mapped into the correct fields of a record to make a record entity representing that object. A pure object oriented approach to storing information thus has substantial disadvantages, such as limitations in data format manipulation and alterations to field and links.

Therefore, there is a need for a database structure and method that can facilitate the storage of multiple types of objects, facilitate the universal searching of such objects by any of the object's attributes without requiring previous knowledge of the record structure of the database, allow for the flexibility of adding dynamic attributes to such records without any modification to existing record structures, allow for dynamic links between such objects without any modification to the existing record structures, and do so all within a single database.

There is also a need for a method of searching that facilitates both absolute and probability searching. Thus, if attributes of an item to be search for are sufficiently well known as to permit the item readily being found in a database, then absolute searching, where all of the attributes are used in the search, may be utilized. It is also desirable to provide a search method wherein the attributes or search terms may be listed in any desired sequence (may be out of sequence).

However, if not all of the attributes needed to locate the item are known, or if some are listed incorrectly in the search request, then those results which are most likely to be the desired results are returned and the user can then review the returned results to locate the desired search result.

### SUMMARY OF THE INVENTION

The present specifically addresses and alleviates the above-mentioned deficiencies associated with contemporary database management systems. More particularly, according to one aspect of the present invention, an information management system comprises an object managing unit for storing data of more than one kind in a common and general format regardless of the kinds of the object data; a format managing unit for storing a format for a specific object of each kind; and a data management control unit for converting the object data between the common general format stored in the object managing unit and the specific format for retrieval based on a respective one of a plurality of filters stored in the filter managing unit, wherein the object data are correlated with filter identifiers, each of which respectively specifies its own corresponding one of the filters.

According to another aspect, the present invention comprises a method for using a database, wherein the method comprises organizing a plurality of data elements within the database such that the data is locatable without a separate index, locating a desired data element in response to a query, and retrieving the located data element. These, as well as other features and advantages of the present invention will be apparent from the following description and drawings. It is understood that changes in the specific structure shown and described may be made within the scope of the claims without departing from the spirit of the invention.

According to one aspect, the present invention comprises a system for searching information object using either probability or absolute methods, which features linearizing attributes of an object for structured and or unstructured data, allowing addition of attributes to an object at run time, and linking objects and managing objects of more than one kind using single or multiple database.

### BRIEF DESCRIPTION OF THE DRAWINGS

These and other features, aspects and advantages of the present invention will be more fully understood when considered with respect to the following detailed description, appended claims and accompanying drawings, wherein:

FIG. 1 is a block diagram showing an electronic device configured to communicate object data between a local server and the internet;

FIG. 2 is a block diagram showing the electronic device of FIG. 1 in further detail;

FIG. 3 is a block diagram of a data object;

FIG. 4 is a block diagram of an object type -n;

FIG. 5 is a block diagram of an object attribute -n;

FIG. 6a-FIG. 6c are block diagrams of a data record structure;

FIG. 7a is a block diagram of a contact object type;

FIG. 7b is a block diagram of a contact object type having data in the data record;

FIG. 8a is a block diagram of a document object type;

FIG. 8b is a block diagram of a document object type having data in the data record thereof;

FIG. 9 is a block diagram of a contract database showing a plurality of records;

FIG. 10 is a block diagram of a contract and document link file;

FIG. 11 is a block diagram of a document knowledge database showing various records;

FIG. 12 is a block diagram of a media (audio/video) knowledge database showing various records;

FIG. 13 is a flowchart illustrating the steps involved in defining a new form object;

FIG. 14 is a flowchart illustrating the steps involved in redefining an existing form object;

FIG. 15 is a flowchart illustrating the steps involved in adding a data object;

FIG. 16 is a flowchart illustrating the steps involved in modifying a data object;

FIG. 17 is a flowchart illustrating the steps involved in storing a form object;

FIG. 18 is a flowchart illustrating the steps involved in deleting a form object;

FIG. 19 is a flowchart illustrating the steps involving in storing a data object, i.e., a form object's attributes;

FIG. 20 is a flowchart illustrating the steps involved in deleting a data object, i.e., a form object's attributes;

FIG. 21 is a flowchart illustrating the steps involved in reading a form object;

FIG. 22 is a flowchart illustrating the steps involved in reading a data object;

FIG. 23 is a flowchart illustrating the steps involved in displaying a data object;

FIG. 24 is a flowchart illustrating the steps involved in an absolute single object search; and

FIG. 25 is a flowchart illustrating the steps involved in a probability based object search of multiple objects.

### DETAILED DESCRIPTION OF THE INVENTION

The detailed description set forth below in connection with the appended drawing is intended as a description of the presently preferred embodiment of the invention, and is not intended to represent the only form in which the present invention may be constructed or utilized. The description sets forth the construction and functions of the invention, as well as the sequence of steps for operating the invention in connection with the illustrated embodiments. It is to be understood, however, that the same or equivalent functions may be accomplished by different embodiments that are also intended to be encompassed within the spirit and scope of the invention.

The present invention comprises an information management system which, unlike contemporary database management systems, is capable of readily storing information having diverse object types. Further, the information management system of the present invention can easily accommodate new object types without requiring the user to have substantial expertise in database management systems since the database structure does not have to be explicitly modified to accommodate the addition of new fields.

The present invention has the ability to add new attributes not previously defined for the records that already exist. This is also done during runtime of the database. Record entities are stored vertically. Our invention has the ability to add, store, and navigate links between objects, which is also during runtime.

The present invention stores these newly added attributes in a method that allows for search of such attributes without specifying what attribute you want to search by. Storage of these attributes can be in a vertical fashion as to enhance the ability to search such attributes and allow for one table to store all the records information. The present invention has the ability to link two objects using an added attribute.

The present invention uses a single relational table with only three columns, for example, to store objects and a second relational table of three columns, for example, to store links between objects. Those skilled in the art will appreciate that any desired number of columns may be used. The number of columns used to store objects may be the same as or different from the number of columns used to store links. Among other things, this structure facilitates the ability to add, store, and navigate links between data objects. Contemporary databases store a separate details table for each object class (or type). The present invention supports the use of multiple object types with no need for additional tables. All the necessary information is stored within the same table as the record itself, as needed.

The database structure and methodology of the present invention is able to be implemented to any form of database system that implements tables for storing records and primary key columns for searching purposes. This idea can be applied by use of multiple tables or even a single table if warranted.

The information management system of the present invention comprises an apparatus and method for the storage and management of data objects. More than one kind of data object is accommodated through the linearization of attributes of the data objects into a single database to provide enhanced search capabilities, as well as the ability to add attributes to an object or links between objects at runtime.

The information management system of the present invention systematically manages and stores data objects of more than one kind through a single database. The system allows applications that use the system to perform operations such as creation, deletion and searching of data objects. Data objects have additional attributes that can also be stored within the same database as the data objects themselves. These attributes can be added and deleted during runtime with no additional modifications to the existing database tables or structure.

Each data object can be found via a search based upon any of its attributes. The ability to add attributes gives the added capability to link such data objects to each other and define a relationship between the objects. This provides extra functionality to any user of an application utilizing this information management system.

The method, format and properties to display such objects' data can also be stored in the same database as the data object itself. The linearization of the attributes for any data object is facilitated by storage of the data vertically by column, rather than horizontally by row. The data object is broken into its principle attributes that gives it definition then the attributes are stored in pieces of the data object, rather than as a whole object. The method allows for storage within one database, as well as flexibility to search for any data object based upon any of its stored attributes in any sequence.

This method also has the added benefit of providing the ability to add attributes or links to such objects with no additional modification of the database table that stores the objects. When a data object is to be reconstructed from its linearized form, it is first sought out through the search for its unique object ID found by way of its attributes and then has all of its attributes found and returned using that object ID. The returned attributes are then used as pieces to build the data object back into a single entry again. The unique object ID is the key for each data object tying together all of the attributes that make that particular data object whole. This nondiscriminatory storage method allows for multiple types of data objects to be stored within a single database with no complications.

Thus, the present invention relates to methods by which a database can be structured and used. That is, the present invention comprises methods by which the database structure stores data in database tables, searches for data within the tables, and retrieves data from the tables.

More particularly, the present invention comprises a method for managing information, wherein the method comprises storing object data of more than one type in a common format; storing a specific format for each type of object data; storing a plurality of filters; and converting the object data between the common general format stored in the object management unit and the specific format for retrieval utilizing a respective one of the filters stored in the filter management unit, wherein the object data has filter identifiers and each filter identifier respectively specifies a corresponding one of the filters.

According to another aspect of the present invention, a method for using a database comprises organizing a plurality of data elements within the database such that the data is locatable without a separate index, locating a desired data element in response to a query, and retrieving the located data element. Optionally, a plurality of data elements within the database are linked to one another. Such linking is preferably performed automatically by the computer. However, linking may also be performed manually by a user.

The method further comprises adding at least one data element, preferably a plurality of data elements, to the database, wherein no predefined field for the data element exists at the time that the data element is initially added. Rather, the field is created by the computer so as to accommodate the new data element. The added data element is organized within the database in a manner which facilitates subsequent location and retrieval of the added data element without the use of a separate index.

The added data element is optionally linked to at least one other data element within the database.

Linking is preferably facilitated by assigning a common number to link data elements. Preferably, the data elements are never erased from the database. However, the data elements may be erased from the database when an explicit command to do so is issued.

The data elements preferably comprise objects. Preferably, the data elements comprise objects of more than one kind. Object data of more than one kind is stored in a common format regardless of the kind of object data. Information representative of the kind of object data is stored in the database. Object data is converted from a native format into a common format for storage in the database. Object data is converted from the common format into a format suitable for use by an application, when the object data is provided to an application. Such conversions is preferably facilitated via the use of a selected one of a plurality of filters which is identified via a filter identifier associated with the object data.

According to the present invention, either absolute or probability searching may be performed. According to absolute searching, the database is searched for an exact match of the search term or terms. According to probability searching, when such an exact match is not found, then one or more of the search terms may be ignored. This typically results in a plurality of search results being returned. The user may then view the returned search results and pick the desired search result.

When probability searching is performed, each search result can optionally be assigned a score which is representative of how well the search results match the search criteria. The search results can then optionally be displayed in order of decreasing relevancy, base upon this score.

Absolute searching provides a more rigid search methodology, whereas probability searching adds flexibility which permits a user to find desired objects in a database when not all of the information necessary to perform an absolute search is known.

Linearization of the database facilitates both absolute and probability searching and enhances overall search efficiency by providing a single field within which all of the search terms are potentially located. That is, only a single linear field needs to be searched in order to find any of the search terms. As those skilled in the art will appreciate, this greatly simplifies the searching process, and consequently substantially enhances searching efficiency and speed. This type of search method is important for natural language processing and corresponds with probability searching, i.e., the way a human thinks.

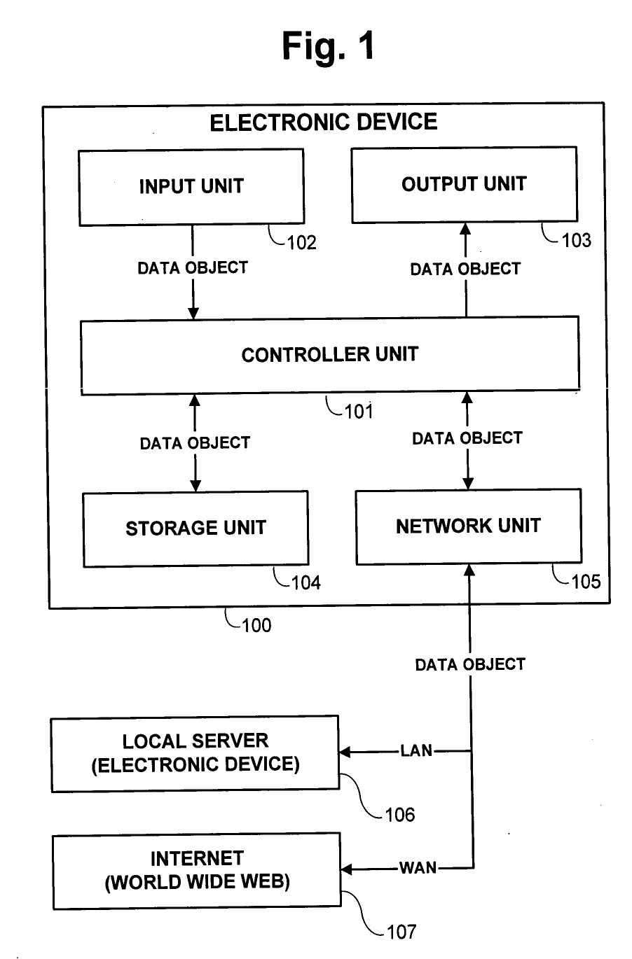

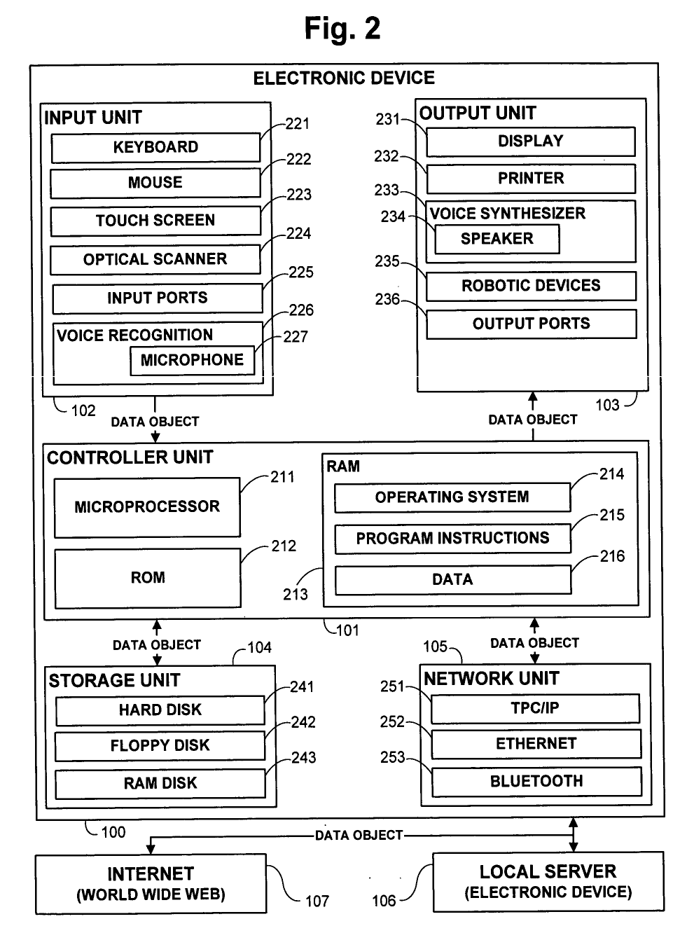

Referring now to FIGS. 1 and 2, an electronic device is loaded with instructions to implement the method of the present invention. The electronic device 100 typically comprises a controller unit 101, an input unit 102, an output unit 103, a storage unit 104, and a networking unit 105. Data object flow takes place from the input unit 102 to controller unit 101, between controller unit 101 and storage unit 104, between controller unit 101, and network unit 105, from controller unit 101 to output unit 103, and among network unit 105, local server 106, and internet 107.

Referring now to FIG. 2, block diagram of an electronic device is illustrated, and is generally identified by the numeral 100. The various input devices 102, which represent user input, as previously described for the present interface system 100 include a keyboard 221, a mouse 222, a touch screen 223, an optical scanner 224, input ports 225, voice recognition device 226 receiving input from a microphone 227. The various output devices 103, which represents controller unit output, include a display 231, a printer 232, speakers 234 receiving signal from voice synthesizer 233, Robotic devices 235, and output ports 236. The controller unit 101 components include a microprocessor 221, and a ROM 212. Various types of RAM 213 where the operating system 214, program instructions 215, and data 216 reside during operation. Various storage unit 104 devices include hard disks 241, floppy disks 242, and ram disks 243. Various network unit 105 devices implementing TPC/IP 251, an Ethernet 252, and/or Bluetooth 253.

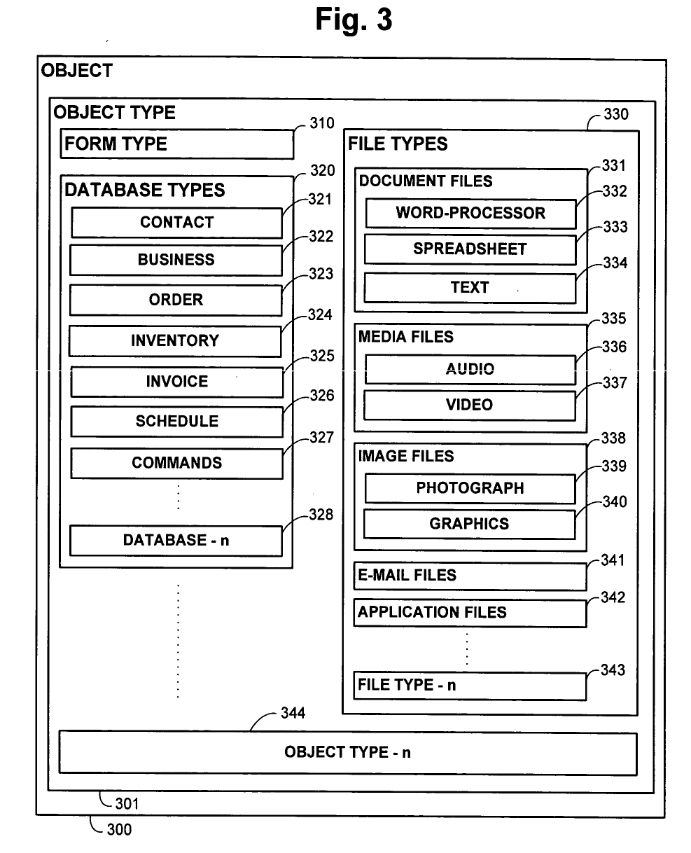

Referring now to FIG. 3, a block diagram of a data object is illustrated, and is generally identified by the numeral 300. The various object types 301 including command types 310, database types 320, file types 330 and object type -n 344. Command types 310 include word 311 and sentence 312 commands. Database types 320 include contact 321, business 322, order 323, inventory 324, invoice 325, schedule 326, home automation 327, and database -n 328 (custom database). File types 330 include document files 331, media files 335, image files 338, email files 341, application files 342, and file type -n 343 (custom file type). Document files 331 include word processor files 332, spreadsheet files 333, and text files 334. Media files 335 include audio files 336 and video files 337. Image files 338 include photograph 339 and graphics 340.

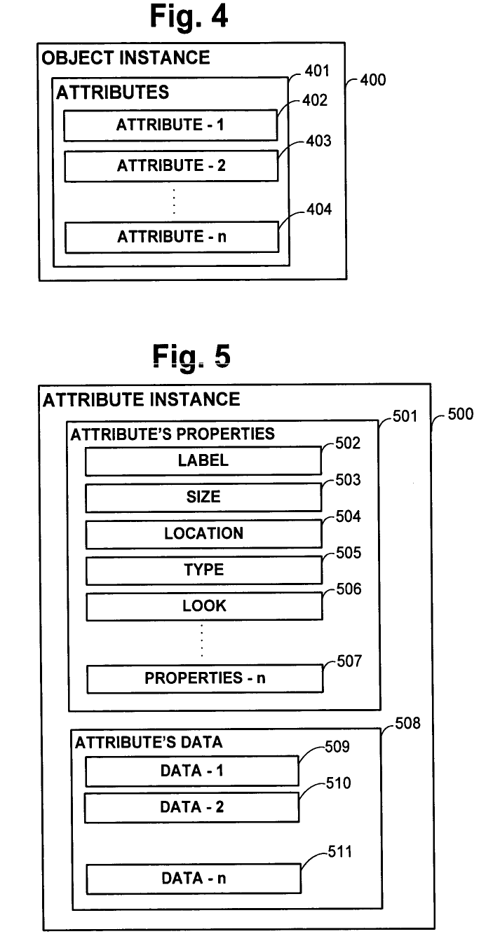

Referring now to FIG. 4, a block diagram of an object type -n is illustrated, and is generally identified by the numeral 400, which includes object attributes 401, which includes object attribute -1 402, object attribute -2 403, and (so on) object attribute -n 404.

Referring now to FIG. 5, a block diagram of an object attribute -n is illustrated, and is generally identified by the numeral 500, which includes name 501, size 502, location 503, type 504, look 505, data records 506 and miscellaneous information -n 510. Data records 506 include record -1 507, record -2 508, and (so on) record -n 509.

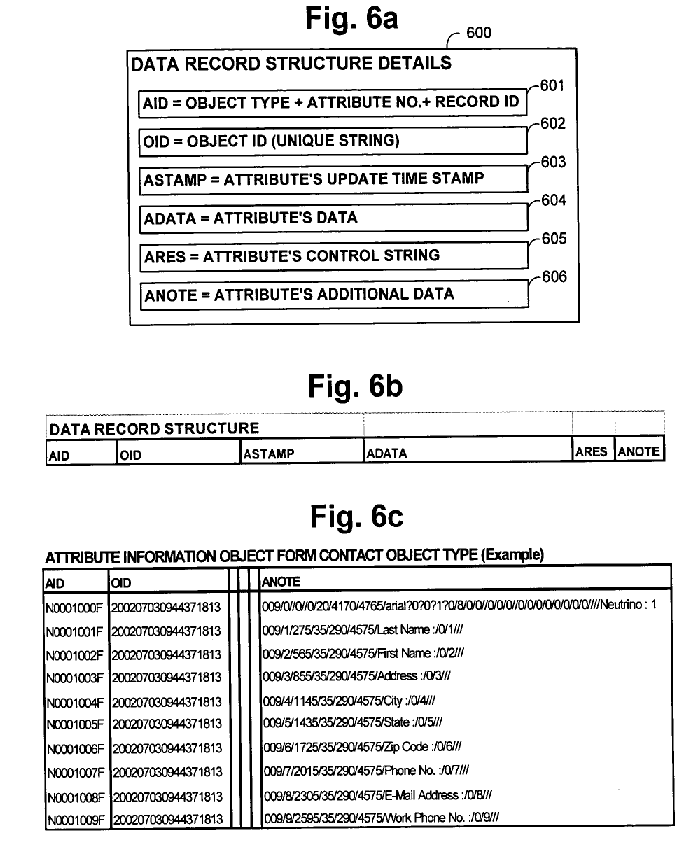

Referring now to FIG. 6a, a block diagram of a data record structure, and is generally identified by the numeral 600, which includes object type 601, object ID 602, object attribute update info 603, object attribute's data 604, object attribute's control string 605, and object attribute's additional data 606.

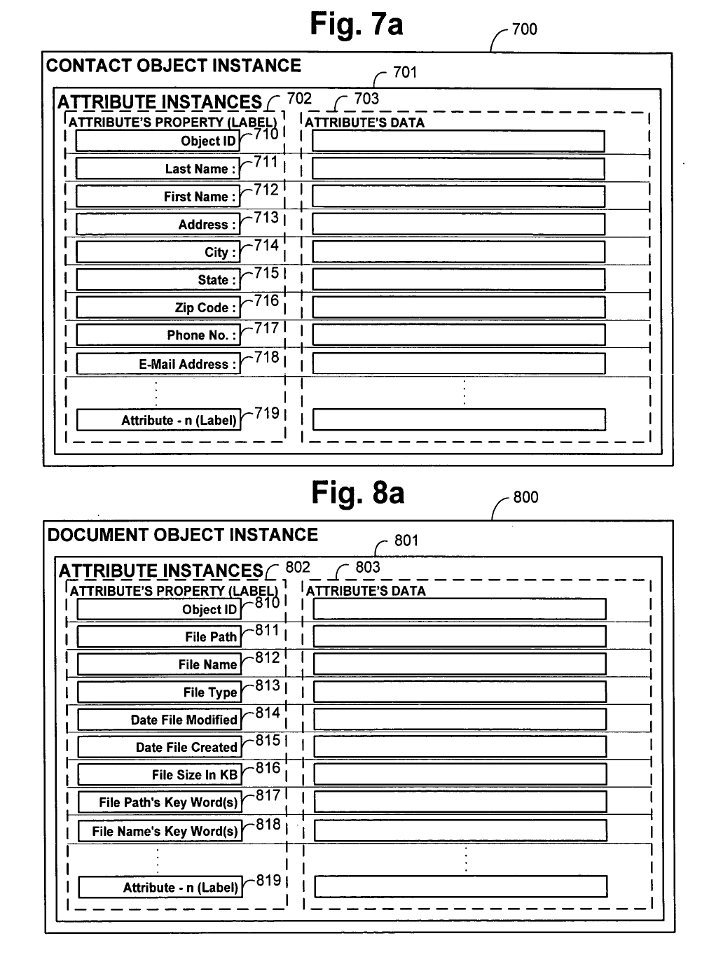

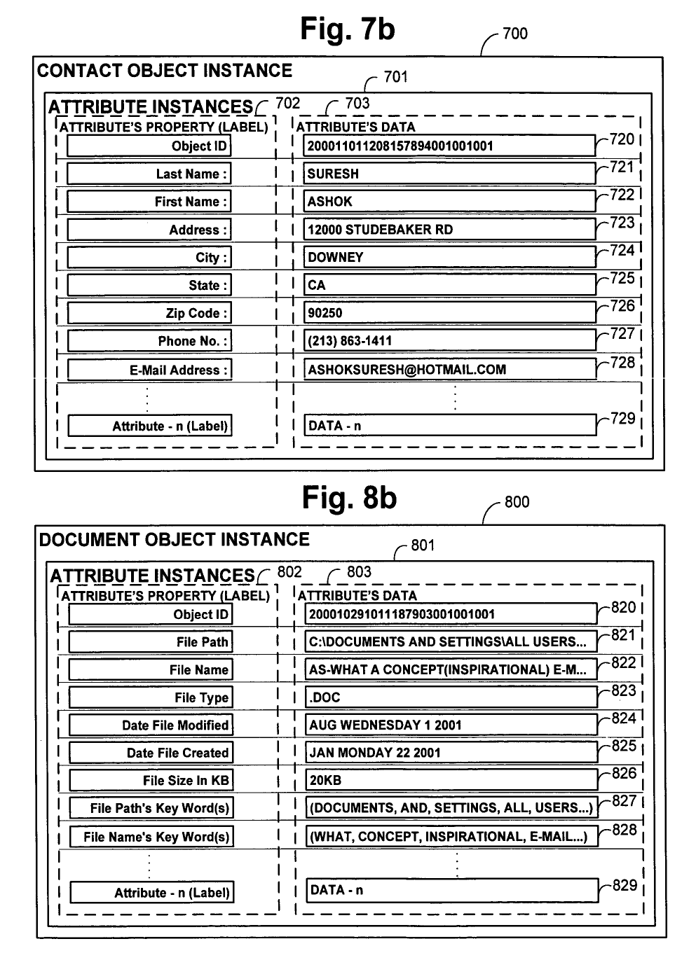

Referring now to FIG. 7a, a block diagram of a contact object type, and is generally identified by the numeral 700, which includes contact object type (example) 701, which includes attributes 702 and data records 703. Attribute 702 includes object ID 710, last name 711, first name 712, address 713, city 714, state 715, zip code 716, phone number 717, e-mail address 718, and (son on) attribute late-n 719 (custom attributes).

Referring now to FIG. 8a, a block diagram of a document object type, and is generally identified by the numeral 800, which includes a document object type (example) 801, which includes attributes 802 and data records 803. Attribute 802 includes object ID 810, file path 811, file name 812, month created 813, year created 814, month updated 815, year updated 816, keyword -1 817, and keyword -2 818, and (so on) keyword -n 819 (custom keywords).

Referring now to FIG. 7b, a block diagram of a contact object type, and is generally identified by the numeral 700, which includes contact object type (example) 701, which includes attributes 702 and data records 703. Attribute 703 includes data record 200011011208157894001001001 720, Suresh 721, Ashok 722, 12000 Studebaker Rd 723, Downey 724, CA 725, 90250 726, (213)863-1411 727, asoksuresh@yahoo.com 728, and (so on) data -n 729.

Referring now to FIG. 8b, a block diagram of a document object type, which is generally identified by the numeral 800, which includes document object type (example) 801, which includes attributes 802, and data records 803. Data record 803 includes 200010291011187903001001001 820, C:/mydocument/anucom inc/patent (full file path) app 821, patent application forms.doc 822, Doc 823, Aug Wednesday 1, 2001 825, application 827, Anucom 828, and (so on) add more keys (inc, forms, .doc, doc, my and document) 829.

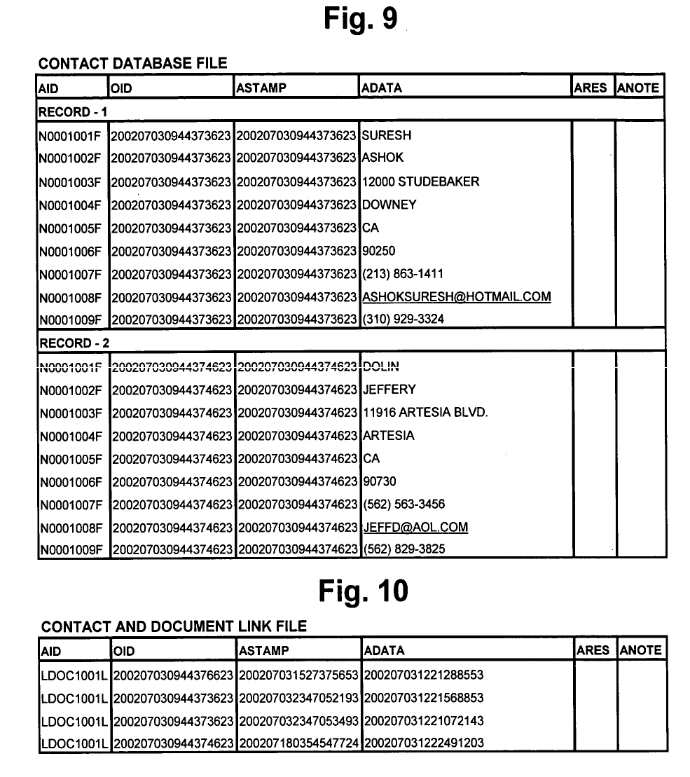

Referring now to FIG. 9, a block diagram of a contract database file showing various records indicating AID (object type, +Attribute No.+Record ID), OID (Object ID [unique string]), ASTAMP (Attribute's update time stamp), ADATA (Attribute's data), AREA (Attribute's control string), and ANOTE (Attribute's additional data).

Referring now to FIG. 10, a block diagram of contract and document link file, showing various records indicating AID (object type, +Attribute No.+Record ID), OID (Object ID [unique string]), ASTAMP (Attribute's update time stamp), ADATA (Attribute's data), AREA (Attribute's control string), and ANOTE (Attribute's additional data).

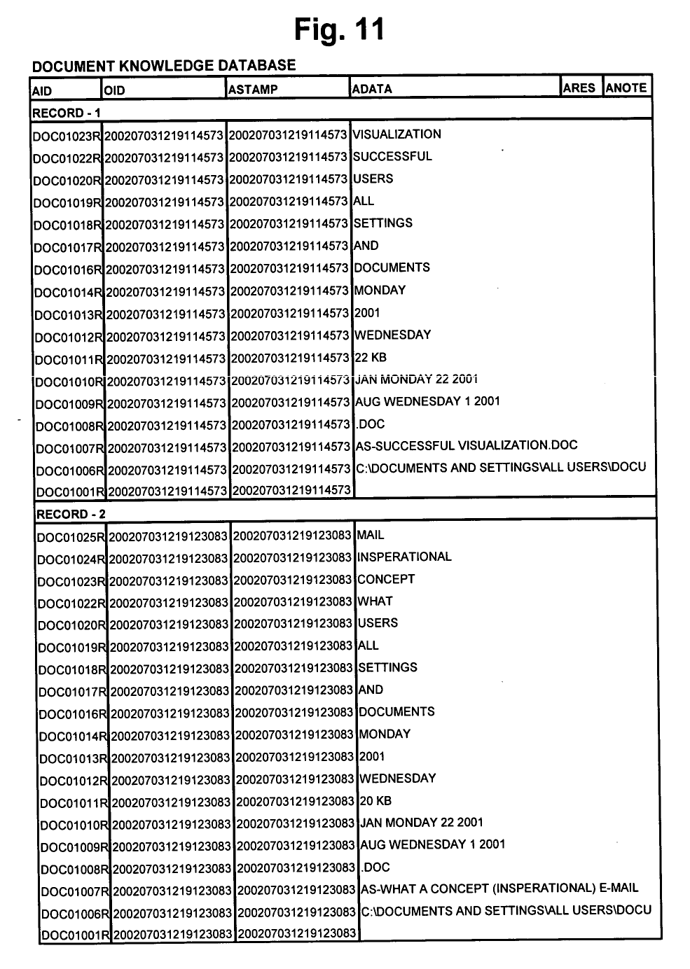

Referring now to FIG. 11, a block diagram of document knowledge database showing various records indicating AID (object type, +Attribute No.+Record ID), OID (Object Id [unique string]), ASTAMP (Attribute's update time stamp), ADATA (Attribute's data), AREA (Attribute's control string), and ANOTE (Attribute's additional data).

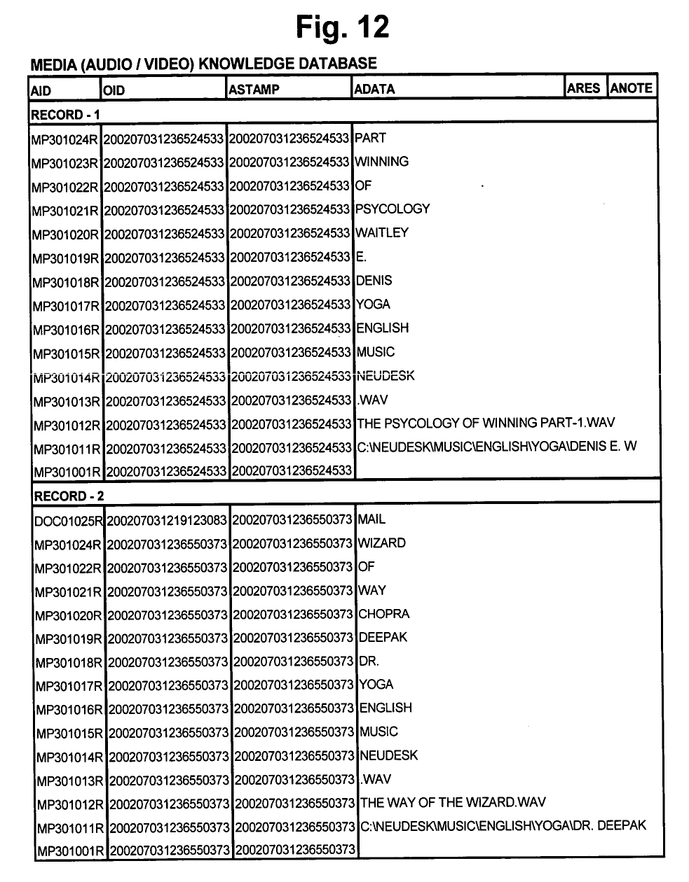

Referring now to FIG. 12, a block diagram of media (audio/video) knowledge database showing various records indicating AID (object type, +Attribute No.+Record ID), OID (Object ID [unique string]), ASTAMP (Attribute's update time stamp), ADATA (Attribute's data), AREA (Attribute's control string), and ANOTE (Attribute's additional data).

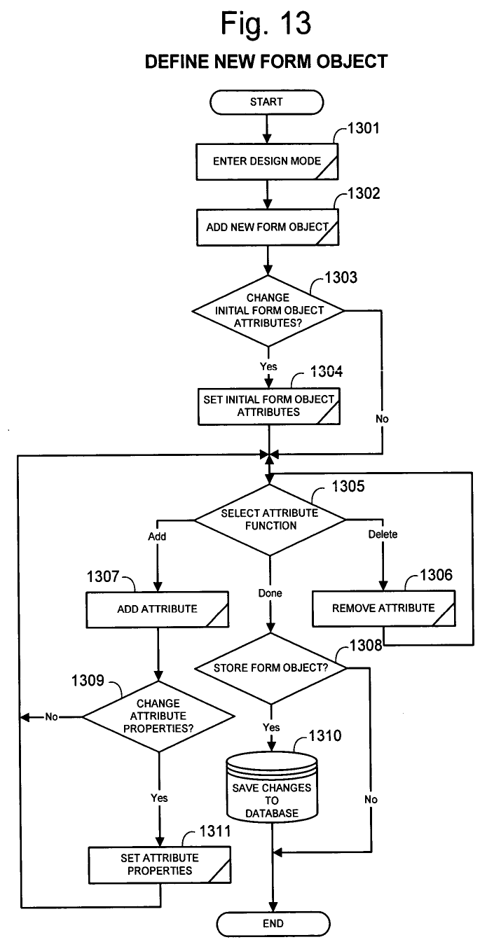

Referring now to FIG. 13, a flowchart illustrating the steps involved in defining a new form object. At the start, we enter the design mode, block 1301, where the form is created. The new form object is then added to the database, block 1302. The option to change the form object's properties, block 1303, is then given. If we opt to change the form object's properties, we set the form object's properties, block 1304, after which we are given an option to select an attribute function: add, delete or done, block 1305. If we opt out of changing the form object's properties, block 1303, we commence directly to the option to select an attribute function, block 1305. If we chose to add an attribute, we go on to add the attribute, block 1307, then giving the option to change that new attribute's properties, block 1309. If we opt to change the attribute's properties, we set the attribute's properties, block 1311, and loop back to select an attribute function, block 1305. If we opt out of changing the attribute's properties, we directly loop back to select an attribute function, block 1305. If we chose to delete an attribute, we remove the attribute, block 1306, and loop back to select an attribute function, block 1305. If we chose that we are done with selecting an attribute function, we are asked if we want to store the form object, block 1308. If we opt to store the form object, changes are saved to the database, block 1310, after which the process ends. If we opt out of storing the form object, we directly reach the end of the process.

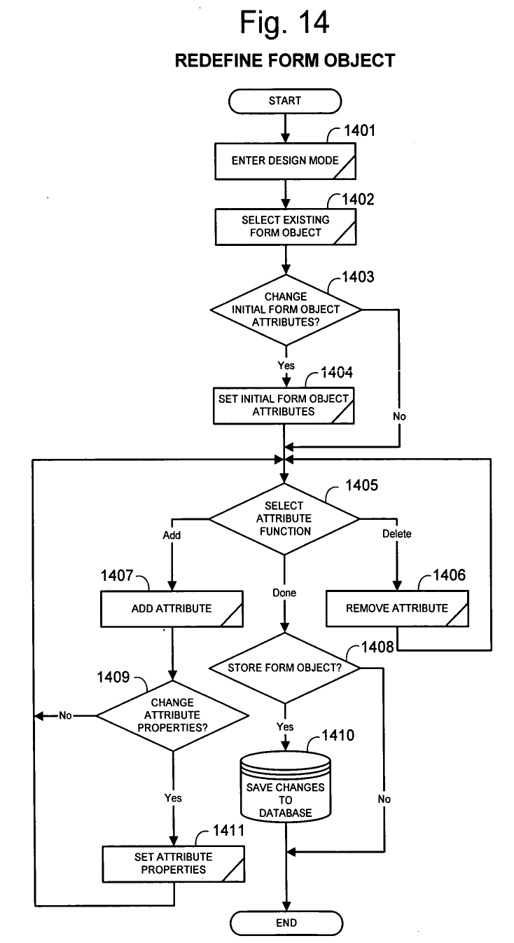

Referring now to FIG. 14, a flowchart illustrating the steps involved in redefining an existing form object. At the start, we enter the design mode, block 1401, where the form is modifiable. The existing form object is then selected to the database, block 1402. The option to change the form object's properties, block 1403, is then given. If we opt to change the form object's properties, we set the form object's properties, block 1404, after which we are given an option to select an attribute function: add, delete or done, block 1405. If we opt out of changing the form object's properties, block 1403, we commence directly to the option to select an attribute function, block 1405. If we chose to add an attribute, we go on to add the attribute, block 1407, then giving the option to change that newly attribute's properties, block 1409. If we opt to change the attribute's properties, we set the attribute's properties, block 1411, and loop back to select an attribute function, block 1405. If we opt out of changing the attribute's properties, we directly loop back to select an attribute function, block 1405. If we chose to delete an attribute, we remove the attribute, block 1406, and loop back to select an attribute function, block 1405. If we chose that we are done with selecting an attribute function, we are asked if we want to store the form object, block 1408. If we opt to store the form object, changes are saved to the database, block 1410, after which the process ends. If we opt out of storing the form object, we directly reach the end of the process.

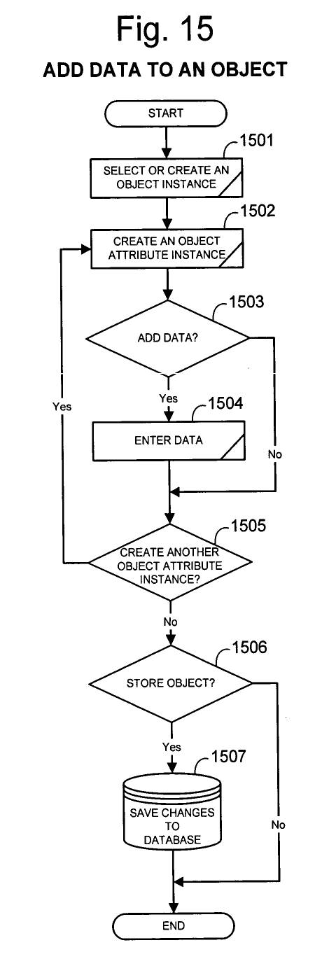

Referring now to FIG. 15, a flowchart illustrating the steps involved in adding a data object. At the start, we begin by adding an empty data object, block 1501. We then proceed to select one of the data object's field(s), block 1502, followed by the option to add data into that field, block 1503. If we opt to add data, we enter the data into the field, block 1504, and proceed to the option to select another one of the data object's fields, block 1505. If we opt not to add data, we directly proceed to the option to select another one of the data object's field, block 1505. At the option to select another one of the data object's fields, block 1505, if we opt to select another field, we loop back to selecting one of the data object's field(s), block 1502. If we opt out of selecting another field, we proceed to the option to store the data object, block 1506. If we opt to save the data object, the changes are saved to the database, block 1507, after which the proceed ends. If we opt out of saving the data object, we directly reach the end of the process.

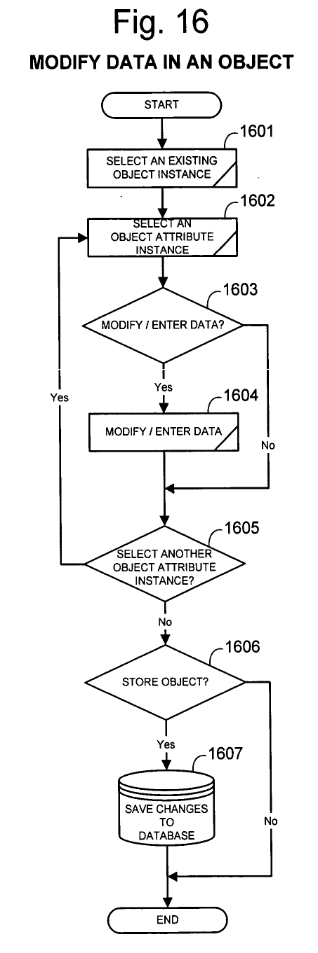

Referring now to FIG. 16, a flowchart illustrating the steps involved in modifying a data object. At the start, we begin by selecting an existing data object, block 1601. We then proceed to select one of the data object's field(s), block 1602, followed by the option to modify or enter data into that field, block 1603. If we opt to modify or enter data, we modify or enter the data into the field, block 1604, and proceed to the option to select another one of the data object's fields, block 1605. If we opt not to modify or enter data, we directly proceed to the option to select another one of the data object's fields, block 1605. At the option to select another one of the data object's field(s), block 1605, if we opt to select another field, we loop back to selecting one of the data object's field(s), block 1602. If we opt out of selecting another field, we proceed to the option to store the data object, block 1606. If we opt to save the data object, the changes are saved to the database, block 1607, after which the process ends. If we opt out of saving the data object, we directly reach the end of the process.

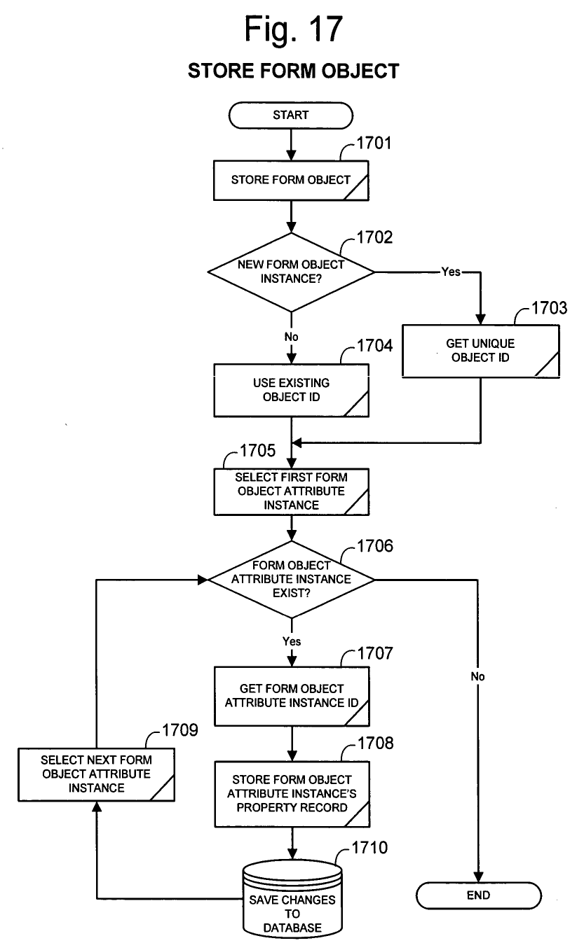

Referring now to FIG. 17, a flowchart illustrating the steps involved in storing a form object. At the start we enter into the process of storing the form object, block 1701, followed by the query of whether this is a new form object, block 1702. If it is a new form object, then we proceed to obtain a unique object ID for this new form object, block 1703. If this is not a new form object, we proceed to use the form object's existing object ID, block 1704. The process then begins iteration through each of the form object's attribute(s) (i.e. data objects). We start by selecting the first attribute of the form object, block 1705, and check to see if that attribute exists, block 1706. If the attribute exists, we obtain the attribute's ID, block 1707, and store the attribute's properties record, block 1708. These changes are then stored to the database, block 1710, and the form object's next attribute is selected, block 1709. We loop back to check if this attribute exists or not, block 1706. If the select attribute function finds no attribute to exist, block 1706, it proceeds to the end of the process.

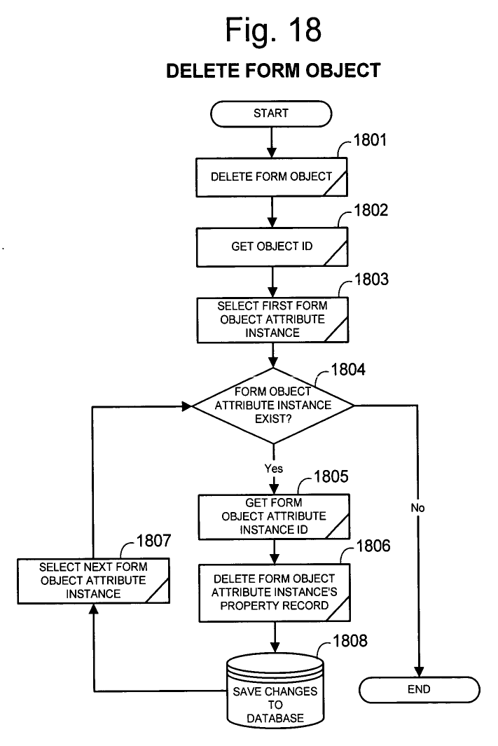

Referring now to FIG. 18, a flowchart illustrating the steps involved in deleting a form object. At the start, we enter into the process of deleting the form object, block 1801, followed by obtain the form object's object ID, block 1802. The process then begins iteration through each of the form object's attribute(s) (i.e. data objects). We start by selecting the first attribute of the form object, block 1803. If the attribute exists, we obtain the attribute's ID, block 1805, and delete the attribute's properties record, block 1806. These changes are then stored to the database, block 1808, and the form object's next attribute is selected, block 1807. We loop back to check if this attribute exists or not, block 1804. If the select attribute function finds no attribute to exist, block 1804, it proceeds to the end of the process.

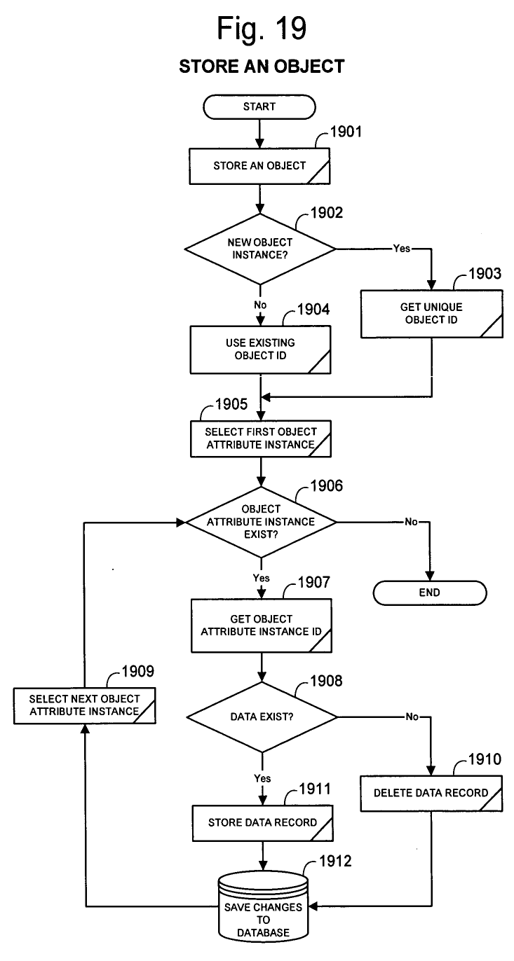

Referring now to FIG. 19, a flowchart illustrating the steps involved in storing a data object (i.e. form object's attributes). At the start, we enter into the process of storing the data object, block 1901, followed by the query of whether this is a new data object, block 1902. If it is a new data object, then we proceed to obtain a unique object ID for this new data object, block 1903. If this is not a new data object, we proceed to use the data object's existing object ID, block 1904. The process then begins iteration through of the data object's attribute(s). We start by selecting the first attribute of the data object, block 1905, and check to see if that attribute exists, block 1906. If the attribute exists, we obtain the attribute's ID, block 1907, and check to see if data exists in the attribute, block 1908. If data exists in the attribute, the data record is stored, block 1911. This is followed by the changes being saved to the database, block 1912. If no data exists in the attribute, the data record is deleted, block 1910, followed by the changes being saved to the database, block 1912. After storing to the database, we select the next attribute of the data object, block 1909. After storing to the database, we select the next attribute of the data object, block 1909. We loop back to check if this attribute exists or not, block 1906. If the select attribute function finds no attribute to exist, block 1906, it proceeds to the end of the process.

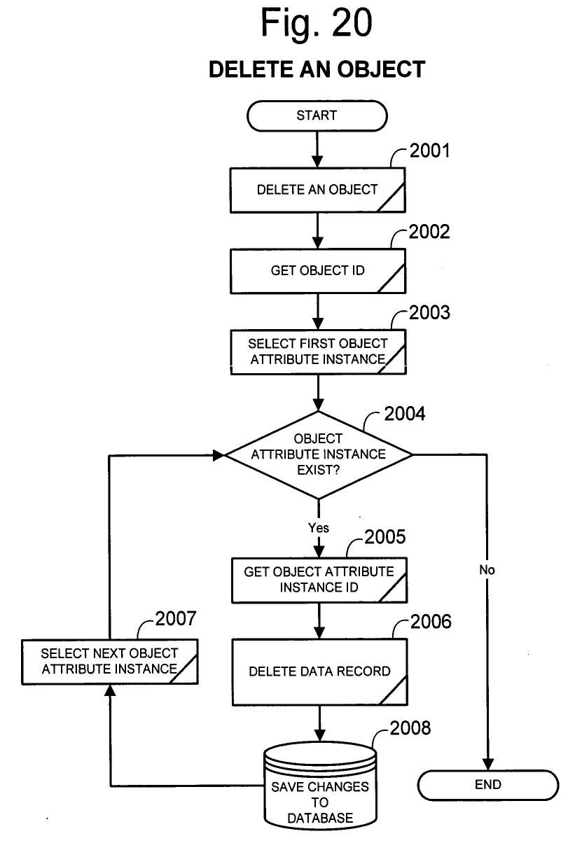

Referring now to FIG. 20, a flowchart illustrating the steps involved in deleting a data object (i.e. form object's attributes). At the start, we enter into the process of deleting the data object, block 2001, followed by obtaining data object's existing object ID, block 2002. The process then begins iteration through each of the data object's attribute(s). We start by selecting the first attribute of the data object, block 2003, and check to see if that attribute exists, block 2004. If the attribute exists, we obtain the attribute's ID, block 2005, and then delete the attribute's data record, block 2006. This is followed by the changes being saved to the database, block 2008. After storing to the database, we select the next attribute of the data object, block 2007. We loop back to check if this attribute exists or not, block 2004. If the select attribute function finds no attribute to exist, block 2004, it proceeds to the end of the process.

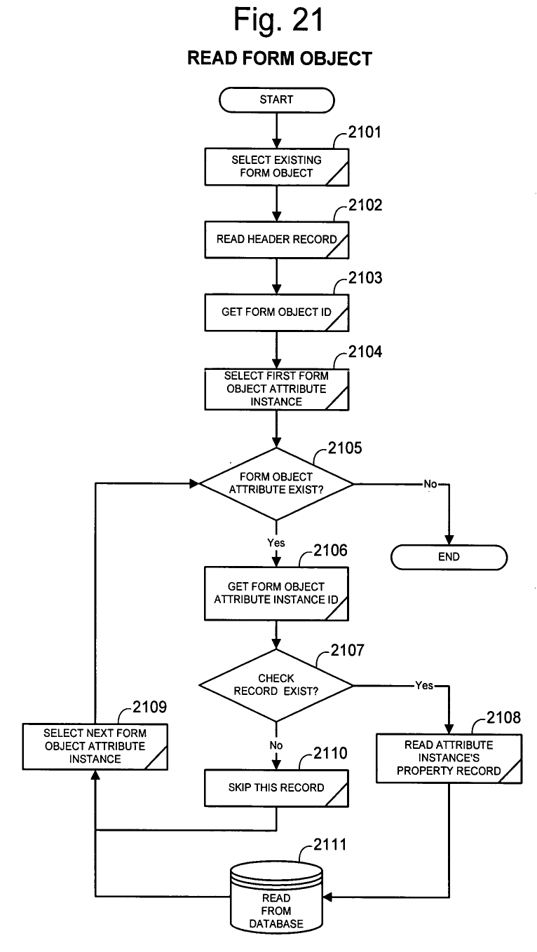

Referring now to FIG. 21, a flowchart illustrating the steps involved in reading a form object. At the start, we enter into the process to reading the form object by selecting an existing form object, block 2101, and then read the header record of that form object, block 2102. We obtain the form object's object ID, block 2103. We start by selecting the first attribute of the form object, block 2104, and check to see if that attribute exists, block 2105. If the attribute exists, we obtain that attribute's ID, block 2106, and then check to see if the record exists, block 2107. If the record exists, we read the attributes properties record, block 2108, and do a read from database, block 2111, followed by a selection of the next form object attribute, block 2109. If the record does not exist, we skip this record, block 2110, and select the next form object attribute. This then loops back to the attribute check, block 2105. If no attribute exists, then the process ends.

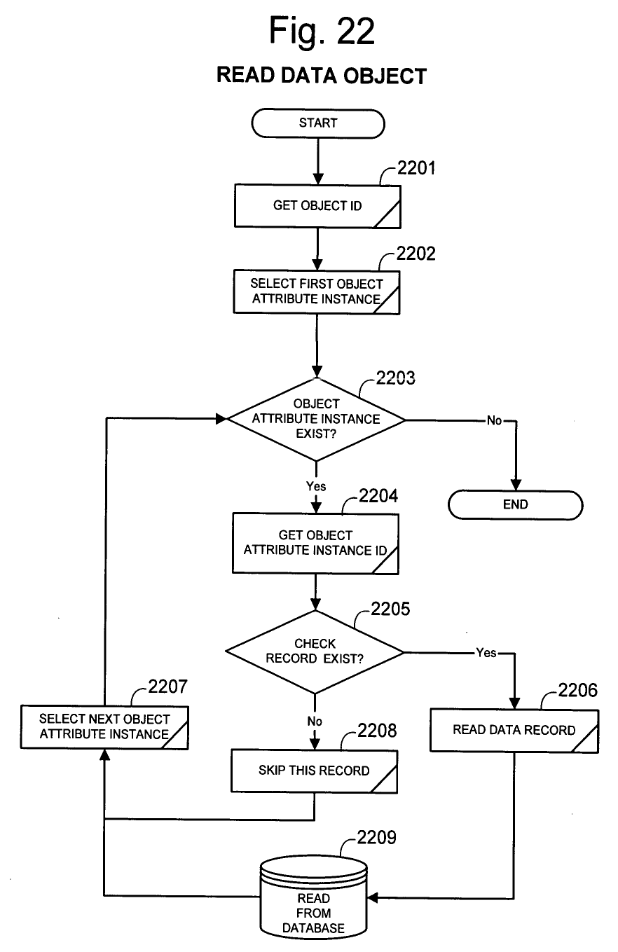

Referring now to FIG. 22, a flowchart illustrating the steps involved in reading a form object. At the start, we enter into the process to reading the data object by obtaining the data object ID, block 2201. We start by selecting the first attribute of the data object, block 2202, and check to see if that attribute exists, block 2203. If the attribute exists, we obtain the attribute's ID, block 2204, and then check to see if the record exists, block 2205. If the record exists, we read the attributes data record, block 2206, and do a read from database, block 2209, followed by a selection of the next data object attribute, block 2207. If the record does not exist, we skip this record, block 2208, and select the next data object attribute. This then loops back to the attribute check, block 2203. If no attribute exists, then the process ends.

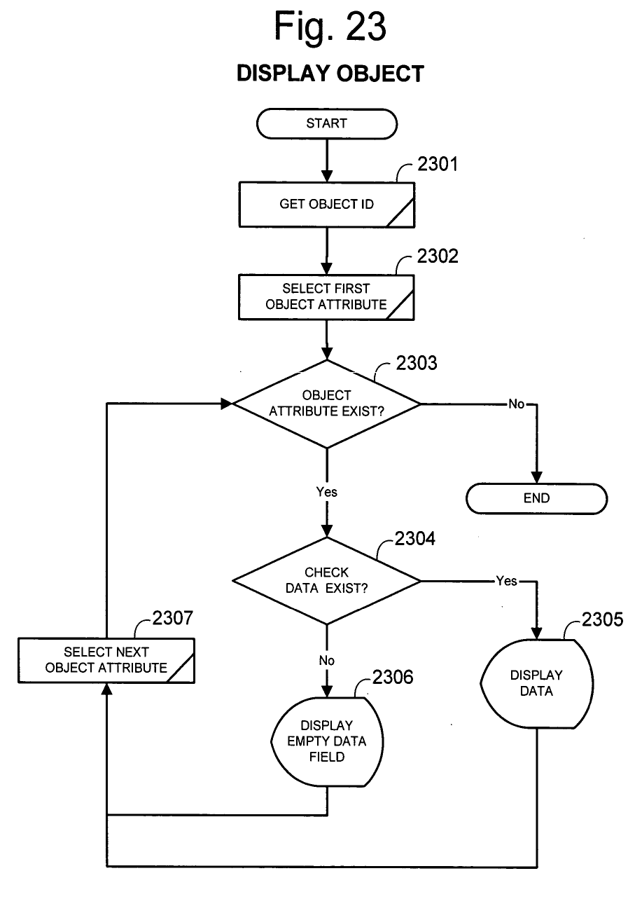

Referring now to FIG. 23, a flowchart illustrating the steps involved in displaying a data object. At the start, we enter into the process to reading the data object by obtaining the data object ID, block 2301. We start by selecting the first attribute of the data object, block 2302, and check to see if that attribute exists, block 2303. If the attribute exists, we check if data exists, block 2304. If data does exist, we display the data, block 2305. If data does not exist, we display empty data field, block 2306. In both cases we follow by a selection of the next attribute of data object. This loops back to attribute check, block 2303. If no attribute exists, then the process ends.

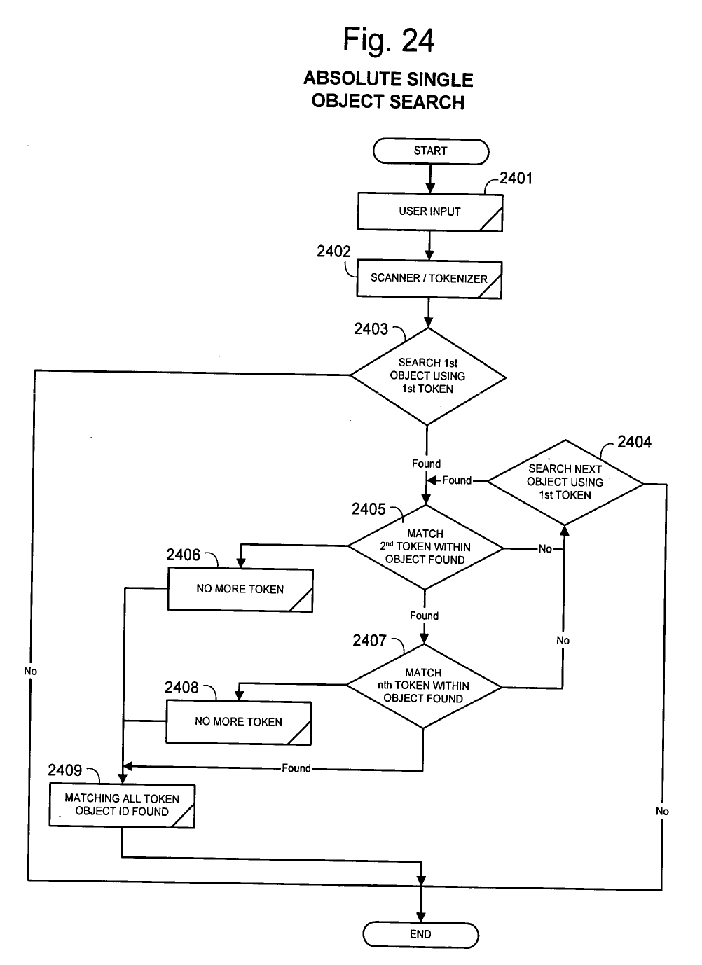

Referring now to FIG. 24, a flowchart illustrating the steps involved in an absolute single object search. At the start, we receive the user's input, block 2401. This input is passed on to the scanner/tokenizer, block 2402. We then check to see if there is any token produced from the tokenizer, block 2403. If there is any token remaining, we then begin the search process by searching the first object using the first token, block 2404, otherwise, we end the process. If the object is found, we check to see if there is any more token left, block 2406. If there is any token remaining, we match the second token within the object found, block 2407, otherwise, we proceed to return the object ID that matches all the tokens, block 2410. If the object is found to match the second token, block 2407, it goes on to check any more token is remaining, block 2408, otherwise, it loops back to searching for the next object that matches the first token, block 2405. If tokens do remain, we continue to keep matching and checking for more tokens for all n tokens that can exist, block 2409, or return the object ID found so far if no more token is left, block 2410. When no more token is left or if all the tokens match one of the object IDs, the object ID matching all the tokens is returned, block 2410, and the process ends.

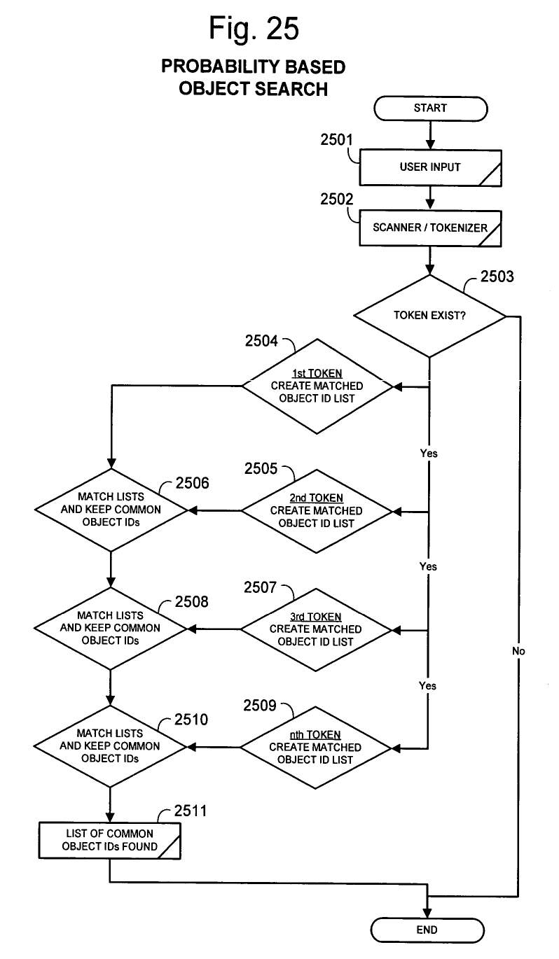

Referring now to FIG. 25, a flowchart illustrating the steps involved in probability based object search of multiple objects. At the start, we receive the user's input, block 2501. This input is passed on to the scanner/tokenizer, block 2502. We then proceed to check if the token exists, block 2503. If no token exists, we end the process. If a token exists, a list of object IDs that match the first token is created, block 2504. Then the next token is taken and an object ID list matching second token is created, block 2505. Taking the first list and the second list, the object ID's held in common are kept, block 2506. Then the next token is taken and an object ID list matching the third token is created, block 2507. This list is then compared to the list of common ID's from the previous lists, block 2508. This continues for all n tokens, block 2509, and the list of common IDs is kept throughout the process, block 2510. In the very end, the list of object IDs found matching all n token is returned, block 2511, after which the process ends.

Having thus described the structure and general operation of the present invention, it may be beneficial to provide some specific examples of the operation thereof.

In order to better describe the present invention an example of inserting a contact record of a person consisting of a first name, last name, and phone number is provided. However, to be able to do this we will have to first define a new form object as shown in FIG. 13. Since we are only demonstrating an example, we will only add three basic fields to the form by changing the properties of the form itself. Each of these fields has an attribute number associated therewith. At this time, the properties of each field is modified to provide for the two name fields and one digits field. Once all these properties are set, this form is stored to the database and assigned an object type. This now defines a contact object type that can now be stored with three fields as shown in FIG. 17.

We can now add a data object record to this defined contact database created, as illustrated in FIG. 15. In our case we will add the first name of “Ashok”, last name of “Suresh”, and phone number of “(213) 345-6789.” Once each of these fields are defined with values, this record is stored to the database with both a particular record ID, that distinguishes it as a unique record among similar types of objects in the database, and a unique object ID that uniquely distinguishes it from any other object entities stored in the database no matter what its object type as shown in FIG. 19.

The object ID is what gives a unique object its identity among all objects in the database as well as links together all the object's attributes. The records for this are stored in the format defined in FIG. 6a. Here it can be seen that the AID consist of the object type, the attribute number, and the record ID. Further, it's the object's unique ID, stored as the OID, which links all its attributes together. This OID is used to determine all the attributes that belong to an object within the database while the attribute number and attributes control string (attributes properties) determine what is being linked to that object and identifies its relationship to the object. The additional fields of the data record contain the time stamp, the attribute's data, and attributes control string. In the case of this contact record, each of the three fields will be split into three data records: first name, last name, and phone number. Each of these records will share the same OID identifying this unique object among all other objects. The AID of each of these records will associate with the contact form we have predefined, while the attribute number distinguishes each of the records as what field of the form it defines. The record ID identifies this record object among all other record objects of the same type defined by the same form object.

Assume, for example, there was a need to add an extra field for e-mails to these contact objects. We would go about adding the field by first redefining the existing form object for contacts as shown in FIG. 14. Here we add the attribute field for e-mails and store the changes to the database via FIG. 17. Now with this new, redefined form, we can go to an existing contact record, say in this case our “Ashok” example, and proceed to fill in the e-mail field that now shows up as part of the form but as containing no value since a record with an OID belonging to this contact object pertaining to this new e-mail field has not been found. This modifying of the contact data object is done via the process shown in FIG. 16. Once we enter a value into this field, a new record is added to the database with the original OID to link it to this object and an AID with the same object type and record ID but the attribute number is different. In this case, this is attribute number 4 where as the first name, last name, and phone number were attributes number 1, 2, and 3 respectively for this contact object type. The object is then stored back to the database with the changed via the process shown in FIG. 19 after the modifications have been completed.

Now, in order to search for this record by way of the universal search of any of its attributes, one would have to decide whether they want an absolute search or probabilistic search of objects, FIGS. 24 and 25 respectively. In the absolute search, the objects returned as results of a query on keywords would have all of the keywords entered found as part of its attributes, regardless of the keywords sequence the user has entered. In a probabilistic search, any objects that have at least one of the keywords entered found as part of its attributes would have that object returned, regardless of the keywords sequence the user has entered. In either case, when the user enters the keywords in for the search, the processes in FIGS. 24 and 25 both go out and search for that keyword in the data fields of each of the records stored. In the case of the contact object type. If I were to type in the keywords “Ashok” and “(213)” as keywords for an absolute search, I would have the OID and contact object for “Ashok” returned to me since both “Ashok” and “(213)” were found to be part of an attribute that belonged to that particular object. If I did a probabilistic search using the same keywords, I would get OID's belonging to objects that have either “Ashok”, “(213)”, or both as part of its object attributes, regardless of the keywords sequence.

Thus the present invention provides an information management system is configured to store more than one type of data object, wherein each different type of data object typically has a different format, and wherein the format of the data stored according to the information management system can be different from the format of the data after the data is retrieved from the information management system. According to another aspect of the present invention, a method for using a database comprises organizing a plurality of data elements within the database such that each data element is locatable without the use of a separate index. The present invention relates to searching of structured as well as unstructured data displaying linearization of objects in database. The search can be absolute exact, or may be based on laws of probability. It has flexibility of expansion of number of attributes to an object at run time.

Thus, the present invention comprises a system for searching for an information object using either probability or absolute methods, which features linearizing attributes of an object for structured and or unstructured data, allowing addition of attributes to an object at run time, and linking objects and managing objects of more than one kind using single or multiple database.

In view of the foregoing, the present invention provides an information management system which readily accommodates the storage and management of diverse types of information and which does not require complex and/or difficult modification of the structure thereof when a new type of information, such as that requiring a new field structure, is added thereto. Searching can be performed without knowledge of the record structure and can be performed upon any of the attributes of records for various different types of objects.

It is important to appreciate that the linear database structure of the present invention facilitates more effective searching. Searching done according to the present invention is more intuitively and more like human thought processes than are contemporary searching methods. Thus, if only certain attributes regarding an item which is being searched can be remembered, then these attributes may result in a successful search. For example, if you are trying to find the name of a person in the database and you can only remember the person's first name, the city in which the person lives, and last four digits of the telephone number, then these items may be entered as search terms. If searching is set up such that only absolute searching is performed, then only the name or names of an individual which exactly match the searched criteria are returned. Optionally, the selection of either absolute or probability searching can be made by either the programmer, the user, or the program itself.

However, if probabilistic searching is done, then a larger number of search results are likely to be returned. For example, if several names meet all of the criteria except the last four digits of the telephone number criteria, then these results will be returned as having a high probability of containing the desired results. The user can then look through the returned result to see if the desired result is contained therein.

According to another aspect of the present invention, a command plus an argument may be entered, so as to result in a desired action upon a desired object. For example, the command may be the word “play” and the argument may be the name of a song. In this instance, the search system need only search through those items in the database which are capable of being played. That is, the search system only needs to look for songs or video clips. This narrowing of the field of search substantially enhances the speed with which such searching is performed.

The present invention facilitates the use of natural language in the searching of databases and the communication of instructions to a computer. Possibly more importantly, the present invention facilitates the use of natural human thought processes in the operation of a computer. That is, the present invention mitigates the need to use the more cumbersome, awkward, and unnatural command structure that is commonly used to control contemporary computers. The use of natural language and natural thought processes is facilitated, at least in part, by structuring computer operation so as to mimic, at least to a substantial degree, human thought processes.

For example, it is much more natural to command the computer with an instruction such as “Play Beethoven's Fifth”, than it is to select a music playing application, then select Beethoven's Fifth from a list displayed by that application or need to know the location of the (MP3) file to start player. Since the present invention associates (links) all of the songs, for example, with a music playing application, for example, in the linearized database, such natural operation is facilitated. Of course, many different types of commands and their associated arguments may be similarly facilitated.

It is understood that the exemplary information management system described herein and shown in the drawings represents only a presently preferred embodiment of the invention. Indeed, various modifications and additions may be made to such embodiment without departing from the spirit and scope of the invention. Thus, various modifications and additions may be obvious to those skilled in the art and may be implemented to adapt the present invention for use in a variety of different applications.

What is claimed is:

1. A method for managing information, the method comprising:
storing object data of more than one type in a common format;
storing a specific format for each type of object data;
storing a plurality of filters; and
converting the object data between the common general format stored in the object management unit and the specific format for retrieval utilizing a respective one of the filters stored in the filter management unit, wherein the object data has filter identifiers and each filter identifier respectively specifies a corresponding one of the filters.

2. An information management system comprising:
an object management unit configured to store object data of more than one type in a common format;
a format management unit configured to store a specific format for each type of object data;
a filter management unit configured to store a plurality of filters; and
a data management control unit configured to convert the object data between the common general format stored in the object management unit and the specific format for retrieval utilizing a respective one of the filters stored in the filter managing unit, wherein the object data has filter identifiers and each filter identifier respectively specifies a corresponding one of the filters.

3. A search method for using a database, the method comprising organizing a plurality of data elements within the database such that the data is locatable without a separate index.

4. The method as recited in claim 3, further comprising performing either an absolute search or a probability search.

5. The method as recited in claim 3, wherein query keys do not have to be provided in any fixed sequence in order to get the same results.

6. The method as recited in claim 3, further comprising storing an element of data in a linearized structure.

7. The method as recited in claim 3, further comprising linking a plurality of data elements within the database to one another.

8. The method as recited in claim 3, further comprising automatically linking a plurality of explicitly related data elements within the database to one another.

9. The method as recited in claim 3, further comprising manually linking a plurality of implicitly related data elements within the database to one another.

10. The method as recited in claim 3, further comprising:
adding at least one data element to the database; and
wherein no predefined field for the data element exists at the time that the data element is added.

11. The method as recited in claim 3, further comprising:
adding at least one data element to the database;
wherein no predefined field for the data element exists at the time that the data element is added; and
wherein the added data element is organized within the database in a manner which facilitates subsequent location and retrieval of the added data element without the use of a separate index.

12. The method as recited in claim 3, further comprising:
adding at least one data element to the database;
linking the added data element to at least one other data element within the database;
wherein no predefined field for the data element exists at the time that the data element is added; and
wherein the added data element is organized within the database in a manner which facilitates subsequent location and retrieval of the added data element without the use of a separate index.

13. The method as recited in claim 3, further comprising:
adding at least one data element to the database;
automatically linking the added data element of at least one explicitly related data element within the database;
wherein no predefined field for the data element exists at the time that the data element is added; and
wherein the added data element is organized within the database in a manner which facilitates subsequent location and retrieval of the added data element without the use of a separate index.

14. The method as recited in claim 3, further comprising:
adding at least one data element to the database;
manually linking the added data element to at least one implicitly related data element within the database;
wherein no predefined field for the data element exists at the time that the data element is added; and
wherein the added data element is organized within the database in a manner which facilitates subsequent location and retrieval of the added data element without the use of a separate index.

15. The method as recited in claim 3, further comprising:
linking a plurality of data elements within the database to one another; and
wherein such linking is facilitate by assigning a common number to linked data elements.

16. The method as recited in claim 3, wherein the data elements are not erased from the database.

17. The method as recited in claim 3, wherein the data elements are not erased from the database until a explicit command to do so is issued.

18. The method as recited in claim 3, wherein the data elements comprise objects.

19. The method as recited in claim 3, wherein the data elements comprise object data of more than one kind.

20. The method as recited in claim 3, wherein the data elements comprise object data of more than one kind stored in a common format regardless of the kind of the object data.

21. The method as recited in claim 3, further comprising storing information representative of the kind of object data in the database.

22. The method as recited in claim 3, further comprising converting object data from a native format into a common format for storage in the database.

23. The method as recited in claim 3, further comprising converting object data stored within the database from a common format into a format suitable for use of the object data by an application.

24. The method as recited in claim 3, further comprising converting object data stored within the database from a common format into a native format of the object data.

25. The method as recited in claim 3, further comprising:
converting object data stored within the database from a common format into a native format of the object data; and
wherein the object data stored within the database is converted from the common format into the native format via a filter selected from a plurality of filter via a filter identified associated with the object data.

26. A data structure for use in a database, the data structure comprising a plurality of data elements organized within the database such that the data is locatable without a separate index.

27. The data structure as recited in claim 26, wherein a plurality of data elements within the database are linked to one another.

28. The data structure as recited in claim 26, wherein a plurality of explicitly related data elements within the database are automatically linked to one another.

29. The data structure as recited in claim 26, wherein a plurality of implicitly related data elements within the database are manually linked to one another.

30. The data structure as recited in claim 26, wherein:
adding at least one data element to the database; and
wherein no predefined field for the data element exists at the time that the data element is added.

31. The data structure as recited in claim 26, further comprising:
at least one data element has been added to the database;
wherein no predefined field for the data element exists at the time that the data element is added; and
wherein the added data element is organized within the database in a manner which facilitates subsequent location and retrieval of the added data element without the use of a separate index.

32. The data structure as recited in claim 26, wherein:
at least one data element has been added to the database;
the added data element is linked to at least one other data element within the database;
wherein no predefined field for the data element existed at the time that the data element was added; and
wherein the added data element is organized within the database in a manner which facilitates subsequent location and retrieval of the added data element without the use of a separate index.

33. The data structure as recited in claim 26, wherein:
at least one data element has been added to the database;
the added data element has been linked to at least one explicitly related data element within the database;
wherein no predefined field for the data element existed at the time that the data element was added; and
wherein the added data element is organized within the database in a manner which facilitates subsequent location and retrieval of the added data element without the use of a separate index.

34. The data structure as recited in claim 26, wherein:
at least one data element has been added to the database;
the added data element the data element has been linked to at least one implicitly related data element within the database;
wherein no predefined field for the data element existed at the time that the data element was added; and
wherein the added data element is organized within the database in a manner which facilitates subsequent location and retrieval of the added data element without the use of a separate index.

35. The data structure as recited in claim 26, wherein:
a plurality of data elements within the database are linked to one another; and
wherein such linking is facilitate by assigning a common number to linked data elements.

36. The data structure as recited in claim 26, wherein the data elements are not erased from the database.

37. The data structure as recited in claim 26, wherein the data elements are not erased from the database until a explicit command to do so is issued.

38. The data structure as recited in claim 26, wherein the data elements comprise objects.

39. The data structure as recited in claim 26, wherein the data elements comprise object data of more than one kind.

40. The data structure as recited in claim 26, wherein the data elements comprise object data of more than one kind stored in a common format regardless of the kind of the object data.

41. The data structure as recited in claim 26, wherein information representative of the kind of object data is stored in the database.

42. The data structure as recited in claim 26, wherein object data is converted from a native format into a common format for storage in the database.

43. The data structure as recited in claim 26, wherein object data stored within the database is converted from a common format into a format suitable for use of the object data by an application.

44. The data structure as recited in claim 26, where object data stored within the database is converted from a common format into a native format of the object data.

45. The data structure as recited in claim 26, wherein:
object data stored within the database is converted from a common format into a native format of the object data; and
wherein the object data stored within the database is converted from the common format into the native format via a filter selected from a plurality of filter via a filter identified associated with the object data.

46. An information management system comprising:
an organizer configured to organize a plurality of data elements within the database such that the data is locatable without a separate index;
a locator configured to locate a desired data element in response to a query; and
retrieving the located data element.

47. The information management system as recited in claim 46, further comprising a linker configured to link a plurality of data elements within the database to one another.

48. The information management system as recited in claim 46, further comprising an automatic linker configured to automatically link a plurality of explicitly related data elements within the database to one another.

49. The information management system as recited in claim 46, further comprising a manual linker configured to manually linking a plurality of implicitly related data elements within the database to one another.

50. The information management system as recited in claim 46, further comprising:
an input device configured to add at least one data element to the database; and
wherein no predefined field for the data element exists at the time that the data element is added.

51. The information management system as recited in claim 46, further comprising:
an input device configured to add at least one data element to the database;
wherein no predefined field for the data element exists at the time that the data element is added; and
wherein the added data element is organized within the database in a manner which facilitates subsequent location and retrieval of the added data element without the use of a separate index.

52. The information management system as recited in claim 46, further comprising:
an input device configured to add at least one data element to the database;
linking the added data element to at least one other data element within the database;
wherein no predefined field for the data element exists at the time that the data element is added; and
wherein the added data element is organized within the database in a manner which facilitates subsequent location and retrieval of the added data element without the use of a separate index.

53. The information management system as recited in claim 46, further comprising:
an input device configured to add at least one data element to the database;
an automatic linker configured to automatically link the added data element of at least one explicitly related data element within the database;
wherein no predefined field for the data element exists at the time that the data element is added; and
wherein the added data element is organized within the database in a manner which facilitates subsequent location and retrieval of the added data element without the use of a separate index.

54. The information management system as recited in claim 46, further comprising:
an input device configured to add at least one data element to the database;
a manual linker configured to manually link the added data element to at least one implicitly related data element within the database;
wherein no predefined field for the data element exists at the time that the data element is added; and
wherein the added data element is organized within the database in a manner which facilitates subsequent location and retrieval of the added data element without the use of a separate index.

55. The information management system as recited in claim 46, further comprising:
a linker configured to link a plurality of data elements within the database to one another; and
wherein such linking is facilitated by assigning a common number to linked data elements.

56. The information management system as recited in claim 46, wherein the data elements are not erased from the database.

57. The information management system as recited in claim 46, wherein the data elements are not erased from the database until a explicit command to do so is issued.

58. The information management system as recited in claim 46, wherein the data elements comprise objects.

59. The information management system as recited in claim 46, wherein the data elements comprise object data of more than one kind.

60. The information management system as recited in claim 46, wherein the data elements comprise object data of more than one kind stored in a common format regardless of the kind of the object data.

61. The information management system as recited in claim 46, further comprising a memory configured to store information representative of the kind of object data in the database.

62. The information management system as recited in claim 46, further comprising a format converter configured to convert object data from a native format into a common format for storage in the database.

63. The information management system as recited in claim 46, further comprising a format converter configured to convert object data stored within the database from a common format into a format suitable for use of the object data by an application.

64. The information management system as recited in claim 46, further comprising a format converter configured to convert object data stored within the database from a common format into a native format of the object data.

65. The information management system as recited in claim 46, further comprising:
a format converter configured to convert object data stored within the database from a common format into a native format of the object data; and
wherein the object data stored within the database is converted from the common format into the native format via a filter selected from a plurality of filter via a filter identified associated with the object data.
